(19) United States
(12) Patent Application Publication
(10) Pub. No.: US 2013/0206437 A1
(43) Pub. Date: Aug. 15, 2013

(54) RECIPROCATING TOOL

(71) Applicant: Hiroyuki Saitou, Ibaraki (JP)

(72) Inventor: Hiroyuki Saitou, Ibaraki (JP)

(73) Assignee: HITACHI KOKI CO., LTD., Tokyo (JP)

(21) Appl. No.: 13/876,894

(22) PCT Filed: Sep. 16, 2011
(86) PCT No.: PCT/JP2011/071770

§ 371 Date: Mar. 29, 2013

(30) Foreign Application Priority Data
Sep. 30, 2010 (JP) 2010-222292

(51) Int. Cl. B27B 19/04

(52) U.S. Cl. CPC B27B 19/04
USPC 173/31

(57) ABSTRACT

A reciprocating tool comprising: a motor configured to rotate around a first rotating shaft; an outer frame that accommodates the motor; a base that is provided at a lower part of the outer frame; a rotating part configured to be rotary driven by the motor around a second rotating shaft, the rotating part including, a gear that is provided on the second rotating shaft, and a pin that is provided at an eccentric position of the gear; a plunger that engages with the pin and is configured to reciprocate in a vertical direction, on a reciprocation axis, in accordance with a vertical movement of the pin; and a curved part that is provided to the plunger, extends in a direction intersecting a reciprocating direction of the plunger and engages with the pin.

### TECHNICAL FIELD

Aspects of the present invention relate to a reciprocating tool configured to cut a work such as wood by reciprocating a blade in a vertical direction by a motor and by pushing and moving a main body forward, and more particularly to a reciprocating tool provided with a mechanism that allows a blade to more easily bite a material to be cut than in a related-art tool.

### BACKGROUND ART

Hereinafter, a related-art reciprocating tool is described by referring to FIGS. 17 to 19.

The reciprocating tool 101 includes a switch 108, a base 105 attached to a lower part that serves as a guide member during a cutting operation, a main body 102 having therein a motor not shown in the drawing and a plunger 110 which reciprocates in a vertical direction by a torque of the motor. The main body 102 includes a housing 103 made of plastic, which transmits the torque of the motor to the plunger 110, and a gear holder 104 provided in the housing 103. An upper part of the plunger 110 is held in the main body 102 so as to freely reciprocate and a lower part of the plunger 110 protrudes outside the main body 102. In the lower part of the plunger 110, a blade 106 is held detachably (see JP-A-2004-1363).

An operation at the time of the cutting operation where the blade 106 moves to an upper dead point from a lower dead point will be described below by referring to FIG. 17. During the cutting operation, a front part of the main body 102 is pulled downward through the plunger 110 from the blade 106 by a vertical reaction force (a cutting reaction force). However, a front part of the base 105 comes into contact with wood to support the main body 102. At this time, since the base 105 strongly comes into contact with the wood under pressure, in a part of the wood and the main body 102 that receives a load, an elastic force is accumulated due to a deformation.

Next, an operation at the time of a returning operation where the cutting operation is finished and the blade 106 moves to the lower dead point from the upper dead point will be described by referring to FIG. 18. During the returning operation, the load applied downward to the front part of the main body 102 through the plunger 110 from the blade 106 is eliminated. Accordingly, when the elastic force accumulated in a front side of the main body 102 with respect a center of gravity 126 is released, the main body 102 is caused to bend rearward with respect to the center of gravity 126. In accordance with the rotating movement of the main body 102, the base 105 located in a rear part with respect to the center of gravity 126 comes into contact with the wood, so that the main body 102 is rotated rearward with respect to the rear end of the base 105 serving as a supporting point.

### SUMMARY OF INVENTION

### Technical Problem

However, when the above-described behavior is repeated, a vibration of the main body 102 is occasionally generated so that a sufficient cutting speed can not be maintained. Further, when a motor of high performance is provided so as to increase the reciprocating speed of the plunger, or when a material to be cut is hard, a problem arises that a biting operation of the blade to the material to be cut deteriorates, and a cutting time increases compared to an expected time.

Accordingly, it is an object of the present invention to solve the above-described problems and provide a reciprocating tool having high operability.

### Solution to Problem

According to an aspect of the present invention, there is provided a reciprocating tool including: a motor configured to rotate around a first rotating shaft; an outer frame that accommodates the motor; a base that is provided at a lower part of the outer frame; a rotating part configured to be rotary driven by the motor around a second rotating shaft, the rotating part including, a gear that is provided on the second rotating shaft, and a pin that is provided at an eccentric position of the gear; a plunger that engages with the pin and is configured to reciprocate in a vertical direction, on a reciprocation axis, in accordance with a vertical movement of the pin; and a curved part that is provided to the plunger, extends in a direction intersecting a reciprocating direction of the plunger and engages with the pin.

### Advantageous Effects of Invention

According to the first aspect, a blade more easily bites a material to be cut and a cutting speed is improved, thereby improving workability.

### BRIEF DESCRIPTION OF DRAWINGS

FIG. 1 is a sectional view of an entire structure of a reciprocating tool according an exemplary embodiment of the present invention;

FIG. 2 is an external appearance view showing a cam and a gear seen from a direction A in FIG. 1;

FIG. 3 is a diagram showing a locus of a saw blade in the reciprocating tool shown in FIG. 1;

FIG. 4 is a diagram showing an operation of a base and the saw blade during a cutting operation of the reciprocating tool shown in FIG. 1;

FIG. 5 is a diagram showing the operation of the base and the saw blade during the cutting operation of the reciprocating tool shown in FIG. 1;

FIG. 6 is a diagram showing the operation of the base and the saw blade during the cutting operation of the reciprocating tool shown in FIG. 1;

FIG. 7 is a diagram showing the operation of the base and the saw blade during the cutting operation of the reciprocating tool shown in FIG. 1;

FIG. 8 is a diagram showing the operation of the base and the saw blade during the cutting operation of the reciprocating tool shown in FIG. 1;

FIG. 9 is a sectional view of the entire structure of the reciprocating tool according the exemplary embodiment of the present invention;

FIG. 10 is a diagram showing a form of a plunger of the reciprocating tool according to the exemplary embodiment of the present invention;

FIG. 11 is an enlarged view of a main part of the plunger shown in FIG. 10;

FIG. 12 is a diagram showing cutting loci of ends of blades in the reciprocating tools of the present invention and related-art;

FIG. 13 is a diagram showing a speed of the blade of the reciprocating tool according to the exemplary embodiment of the present invention;

FIG. 14 is a diagram showing a second shape of the plunger of the reciprocating tool according to the exemplary embodiment of the present invention;

FIG. 15 is an enlarged view of a main part of FIG. 14;

FIG. 16 is a diagram showing a speed of a blade when the plunger of the reciprocating tool according to the exemplary embodiment of the present invention has the second shape;

FIG. 17 is a diagram of an entire structure of a related-art reciprocating tool;

FIG. 18 is a diagram of an entire structure of a related-art reciprocating tool;

FIG. 19 is a sectional view of the entire structure of the related-art reciprocating tool; and

FIG. 20 is a front sectional view of the entire structure of the related-art reciprocating tool.

### DESCRIPTION OF EMBODIMENTS

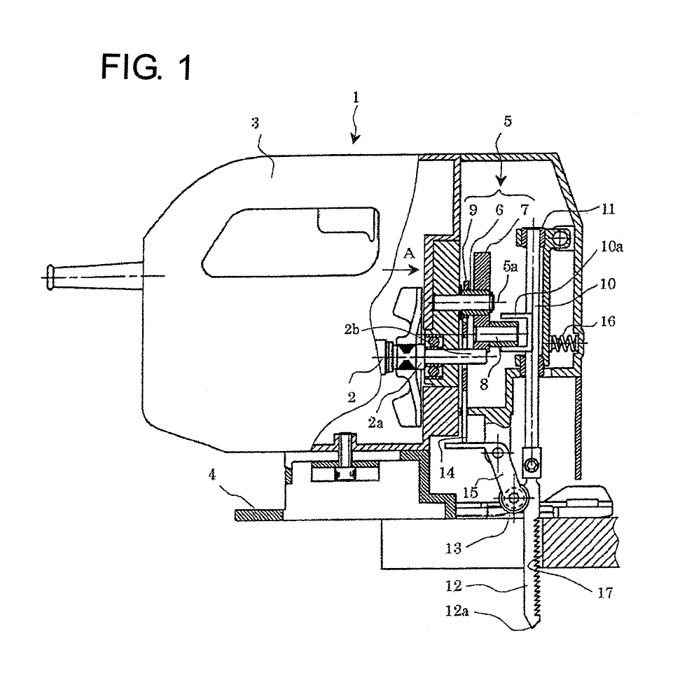

A reciprocating tool according to an exemplary embodiment of the present invention will be described by referring to FIGS. 1 to 16. In the description of the reciprocating tool, a right part of FIG. 1 is designated as a front part of the reciprocating tool 1, a left part of FIG. 1 is designated as a rear part of the reciprocating tool 1, an upper part of FIG. 1 is designated as an upper part of the reciprocating tool 1 and a lower part of FIG. 1 is designated as a lower part of the reciprocating tool 1.

As shown in FIG. 1, the reciprocating tool (a jigsaw) 1 includes a motor 2 that rotates around a rotating shaft 2a extending in a front-rear direction, a housing 3 as an outer frame for accommodating the motor 2 and a base 4 provided in a lower part of the housing 3.

In the housing 3, a rotating part 5 is provided which engages with a pinion 2b formed in an end of the rotating shaft 2a to be driven and rotated. The rotating part 5 includes a spindle 6 as a rotating shaft, a gear 7 provided on the spindle 6, a pin 8 provided at an eccentric position of the gear 7 and a cam 9 provided on the spindle 6.

In a front part of the rotating part 5, a plunger 10 is provided. The plunger 10 is formed of plate shaped member which extends in an upper-lower direction. A pin engaging part (a curved part) 10a which engages with the pin 8 is provided in an intermediate part of the plunger and is configured to move upward and downward by the rotation of the pin 8. At a lower end of the plunger 10, a saw blade 12 having saw teeth in a front part thereof is attached so as to intersect the base 4. Accordingly, when the rotating part 5 is rotated, the pin 8 performs an eccentric movement to move the plunger 10 and the saw blade 12 upward and downward.

The plunger 10 is supported by a plunger holder 11 so as to be movable in the upper-lower direction. The plunger holder 11 is supported by the housing 3 so as to be able to oscillate forward and backward and pressed rearward by a spring 16 provided between the plunger holder 11 and the housing 3. Accordingly, the saw blade 12 is pressed to a roller 13, which will be described later, provided at a rear side thereof.

The cam 9 has a substantially disk shape. However, as will be described later, an outer peripheral surface of the cam 9 is formed so that a distance between the outer peripheral surface of the cam 9 and a center of a rotation shaft 5a of the rotating part 5 changes as the cam 9 rotates. An intermediate member 14, which is supported by the housing 3 so as to be movable in the upper-lower direction, abuts on the outer peripheral surface of the cam 9. A roller holder 15, which is supported by the housing 3 so as to be able to oscillate in a front-rear direction, is provided lower to the intermediate member 14. The roller holder 15 is formed in a substantially L-shape and has one end abutting on the intermediate member 14 and another end supporting the roller 13 so as to be rotatable. Thus, when the rotating part 5 is rotated, the intermediate member 14 moves in the upper-lower direction in accordance with the form of the outer peripheral surface of the cam 9 so that the roller holder 15 rotates. Further, based on the rotation of the roller holder 15, the roller 13 causes the saw blade 12 to move in the front-rear direction.

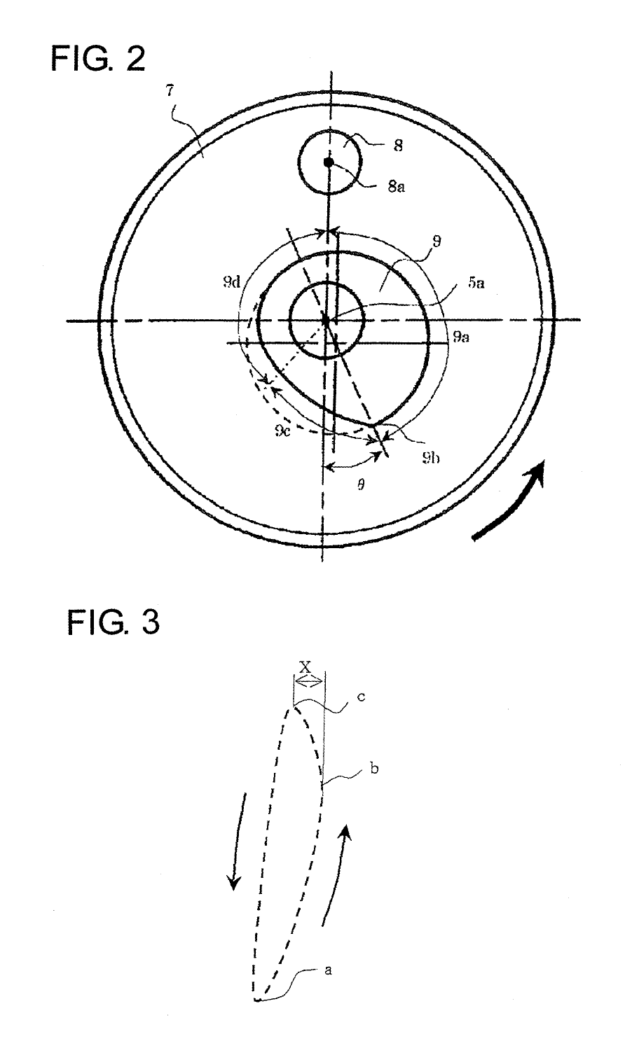

FIG. 2 is a diagram showing the cam 9 and the gear 7 seen from a direction A in FIG. 1. A thick arrow mark drawn in a right lower part of FIG. 2 shows a rotating direction of the cam 9 and the gear 7. On the outer peripheral surface of the cam 9, a top part 9b is formed whose distance from the center of the rotation shaft 5a is the largest. In a rotating direction side of the top part 9b, a first area 9a is formed in which a distance from the center of the rotation shaft 5a increases as the cam 9 rotates. In a side opposite to the rotating direction side of the top part 9b, a second area 9c is formed in which the distance from the center of the rotation shaft 5a decreases as the cam 9 rotates. In a side opposite to a top part side of the second area 9c, a third area 9d is formed. In the third area 9d, as the cam rotates, the distance from the center of the rotation shaft 5a decreases slightly. However, since a rate of change of the distance from the center of the rotation shaft 5a is greatly smaller in the third area 9d than in the second area 9c, hereinafter, the third area 9d will be described separately from the second area 9c.

According to the above-described configuration, a lower end 12a of the saw blade 12 moves on a locus as shown in FIG. 3 in such a way that the lower end 12a traces an lowermost point “a”, a foremost point “b” and an uppermost point “c” in order as shown by arrow marks. The locus of the saw blade 12 shown in FIGS. 3 to 8 is actually more elongated in the upper-lower direction. However, the locus is drawn to be stretched in the transverse direction so as to be easily seen.

The rate of change of the distance between the second area 9c and the center of the rotation shaft 5a is configured to be larger than the rate of change of the distance between the first area 9a and the center of the rotation shaft 5a so that the saw blade 12 is drastically set back from a surface 17 to be cut. Here, the rate of change of the distance from the center of the rotation shaft 5a means an amount of change of the distance from the center of the rotation shaft 5a when the cam 9 rotates by a prescribed angle.

Further, the present exemplary embodiment gives an attention to a fact that when the saw blade 12 reaches the uppermost point “c”, if the saw blade 12 is separated from the surface 17 to be cut, an instantaneous change of a force applied to a main body is mitigated. When it is defined that a retreating amount obtained until the saw blade 12 reaches the uppermost point “c” from the foremost point “b” is X, the saw blade 12 should separate from the surface 17 to be cut earlier as the retreating amount X increases. A reciprocating tool whose retreating amount X is set to about 0.3 mm has been known. However, a reciprocating tool whose retreating amount X is larger than about 0.3 mm has not been known. Thus, an experiment has been carried out by setting the retreating amount X to about 0.9 mm According to the experiment it is recognized that vibration is extremely reduced compared the known reciprocating tool when a cutting operation is carried out by strongly pushing the reciprocating tool 1 forward. From this result, it can be supposed that even when the retreating amount X is set to about 0.6 mm, the vibration will be reduced compared to the known case. Further, it can be supposed that, when the retreating amount is set to about 0.8 mm, the vibration will be extremely reduced. In the experiment, an Oregon pine material which is frequently used in a 2×4 construction method is employed, an ordinary pressing force is set to about 2.0 kgf and a strong pressing force is set to about 4.0 kgf.

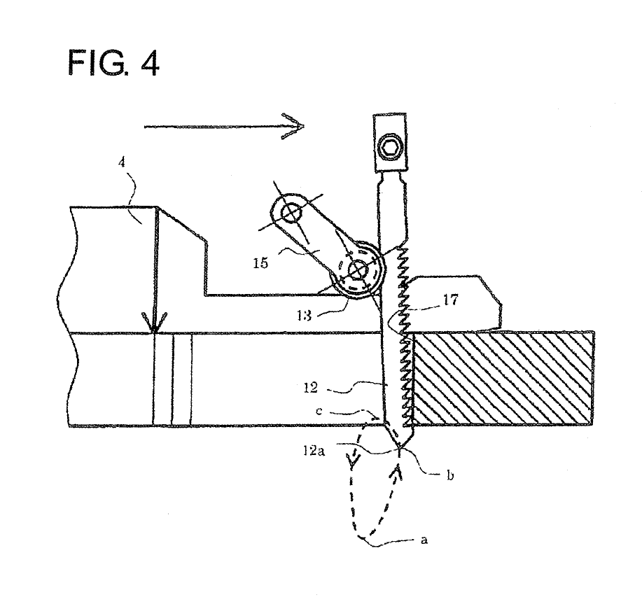

FIGS. 4 to 8 show operations of the base 4 and the saw blade 12 in order when the cutting operation is carried out by the reciprocating tool 1. An arrow mark drawn in an upper part of each drawing shows an advancing direction of the base 4. An arrow mark attached to the base 4 and three vertical lines attached to a work in a lower part thereof designate marks shown in order to easily understand to what degree the base 4 advances relative to the work.

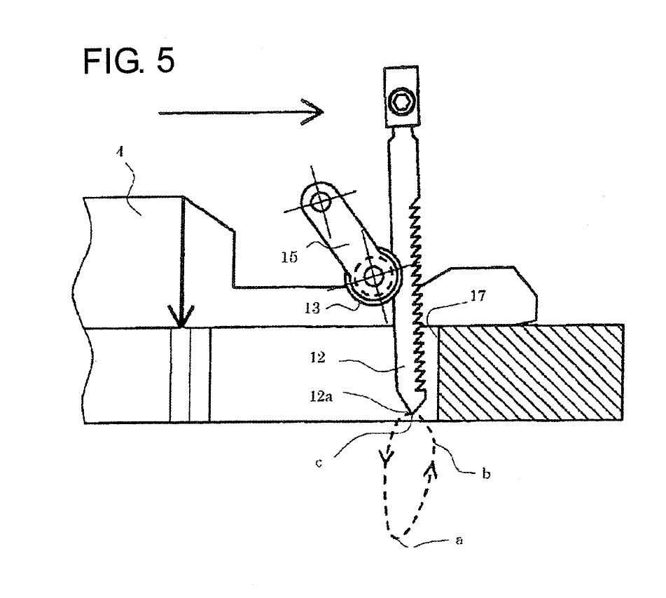

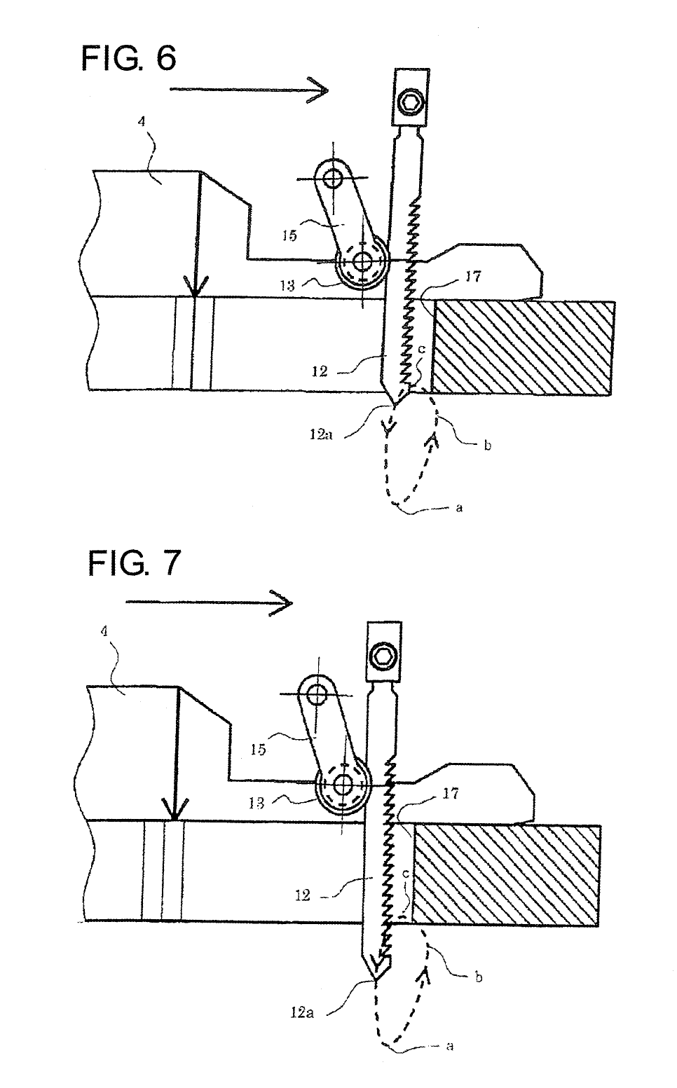

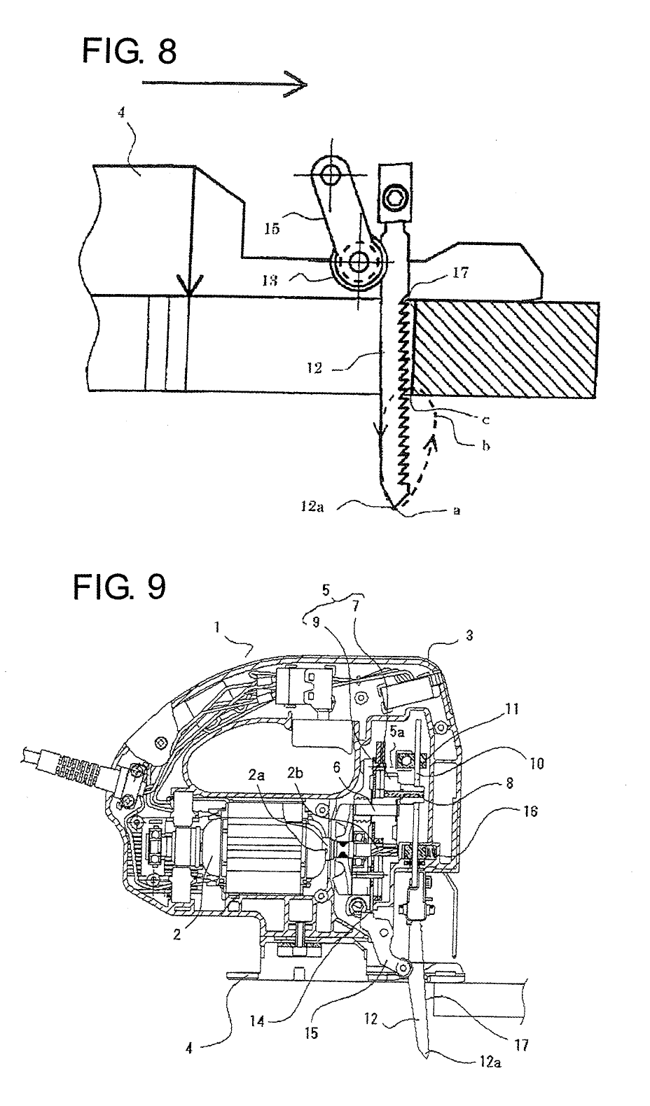

FIG. 4 shows a state that the saw blade 12 finishes a sawing operation and reaches the foremost point “b”. From this time, the saw blade 12 begins to retreat. As shown in FIG. 5, at the time when the saw blade 12 reaches the uppermost point “c” and is switched to a lowering operation from a lifting operation, the saw blade 12 is separated from the surface 17 to be cut. Then, via states shown in FIG. 6 and FIG. 7, the saw blade 12 reaches the lowermost point “a” as shown in FIG. 8. From here, the saw blade 12 is switched to the lifting operation from the lowering operation, and then, advances and continues the sawing operation until the saw blade 12 reaches the foremost point “b” again. Subsequently, the above-described operations are repeated.

As described above, according to the present invention, even when an operator strongly pushes a main body forward and performs operation, an instantaneous change of a force applied to the main body is mitigated to reduce a vibration. Further, chips are easily discharged and an unnecessary friction is eliminated between the saw blade 12 and the surface 17 to be cut to improve a cutting property. Accordingly, the reciprocating tool can be provided which has little vibration and is excellent in its cutting property.

As shown in FIG. 9, a reciprocating tool 1 having a different form from that shown in FIG. 1 includes a motor 2 that rotates around a rotating shaft 2a extending in the front-rear direction, a housing 3 as an outer frame for accommodating the motor 2 and a base 4 provided in a lower part of the housing 3.

In the housing 3, a rotating part 5 is provided which engages with a pinion 2b formed in an end of the rotating shaft 2a to be rotary driven. The rotating part 5 includes a spindle 6 as a rotating shaft, a gear 7 provided on the spindle 6, a pin 8 provided at an eccentric position of the gear 7 and a cam 9 provided on the spindle 6.

In a front part of the rotating part 5, a plunger 10 is provided. The plunger 10 is formed with a plate shaped member which extends in the upper-lower direction. A pin engaging part (a curved part) 10a which is engaged with the pin 8 is provided in an intermediate part of the plunger and is configured to move upward and downward by the rotation of the pin 8. At a lower end of the plunger 10, a saw blade 12 having saw teeth in a front part thereof is attached so as to intersect the base 4. Accordingly, when the rotating part 5 is rotated, the pin 8 makes an eccentric movement to move the plunger 10 and the saw blade 12 upward and downward.

The plunger 10 is supported by a plunger holder 11 so as to be movable in the upper-lower direction. The plunger holder 11 is supported by the housing 3 so as to be able to oscillate forward and backward and pressed rearward by a spring 16 provided between the plunger holder 11 and the housing 3. Accordingly, the saw blade 12 is pressed to a roller 13, which will be described later, provided at a rear side thereof.

The cam 9 has a substantially disk shape. However, as previously described, an outer peripheral surface of the cam 9 is formed so that a distance between the outer peripheral surface of the cam 9 and a center of a rotation shaft 5a of the rotating part 5 changes as the cam 9 rotates. An intermediate member 14, which is supported by the housing 3 so as to be movable in the upper-lower direction, abuts on the outer peripheral surface of the cam 9. A roller holder 15, which is supported by the housing 3 so as to be able to oscillate in a front-rear direction, is provided lower to the intermediate member 14. The roller holder 15 is formed in a substantially L-shape and has one end abutting on the intermediate member 14 and the other end supporting the roller 13 so as to be rotatable. Thus, when the rotating part 5 is rotated, the intermediate member 14 moves in the upper-lower direction in accordance with the form of the outer peripheral surface of the cam 9 so that the roller holder 15 rotates. Further, based on the rotation of the roller holder 15, the roller 13 causes the saw blade 12 to move in the front-rear direction.

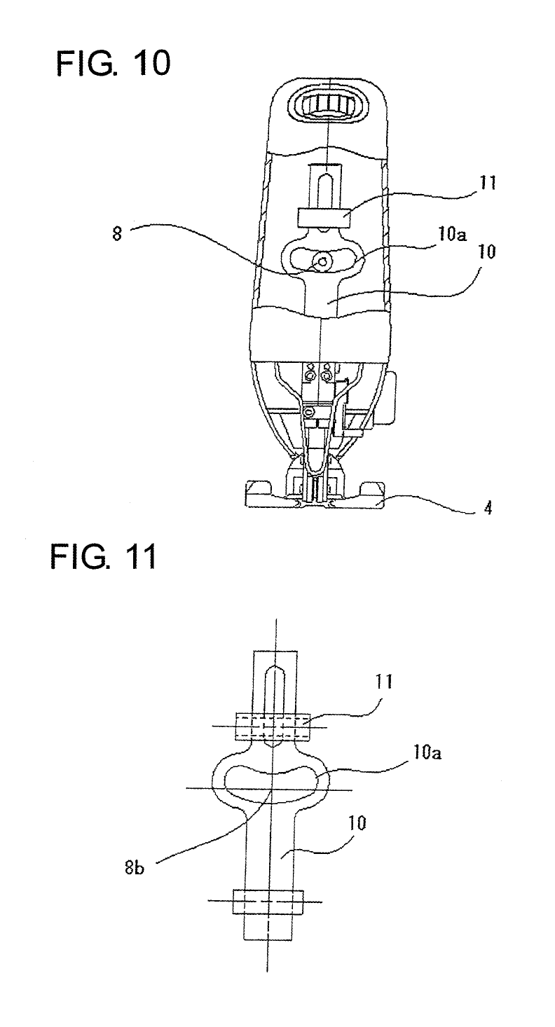

FIG. 10 shows the plunger 10 in the exemplary embodiment of the present invention and is a sectional view showing the reciprocating tool 1 seen from a cutting direction. The plunger 10 supported by the plunger holder 11 slides in the upper-lower direction relative to the plunger holder 11. In the plunger 10, the curved part 10a which engages with the pin 8 is transversely formed in the direction intersecting the upper-lower direction in which the plunger 10 is configured to reciprocate. The pin 8 passes through the curved part 10a. The curved part 10a is formed in a substantially line symmetrical shape with respect to an axis on which the plunger 10 reciprocates. As one example, when the base 4 is seen as a lower part, the curved part 10a is formed in a substantially U-shape. Although the curved part 10a is formed in a substantially U-shape in FIG. 10, the curved part may be formed in an inverted U-shape, etc. Further, a radius R of a curve of the curved part 10a may take various values depending on products. In such a configuration, since the blade bites a material to be cut at a speed lower than a usual speed and the locus of the blade before and after the blade bites the material to be cut is deeper than that of a usual locus, a cutting speed is improved as a whole, thereby improving workability. FIG. 10 shows a state where the plunger 10 is in an upper dead point. When the pin 8 moves in a right direction in FIG. 10, the plunger 10 moves in the lower direction.

FIG. 11 is an enlarged view of a main part of the plunger 10 shown in FIG. 10. The pin 8, which is configured to rotate on the rotation shaft 5a, is located on the axis, on which the plunger 10 is configured to reciprocate, at a central point 8b. The central point 8b is located at a center in the transverse direction of the curved part 10a.

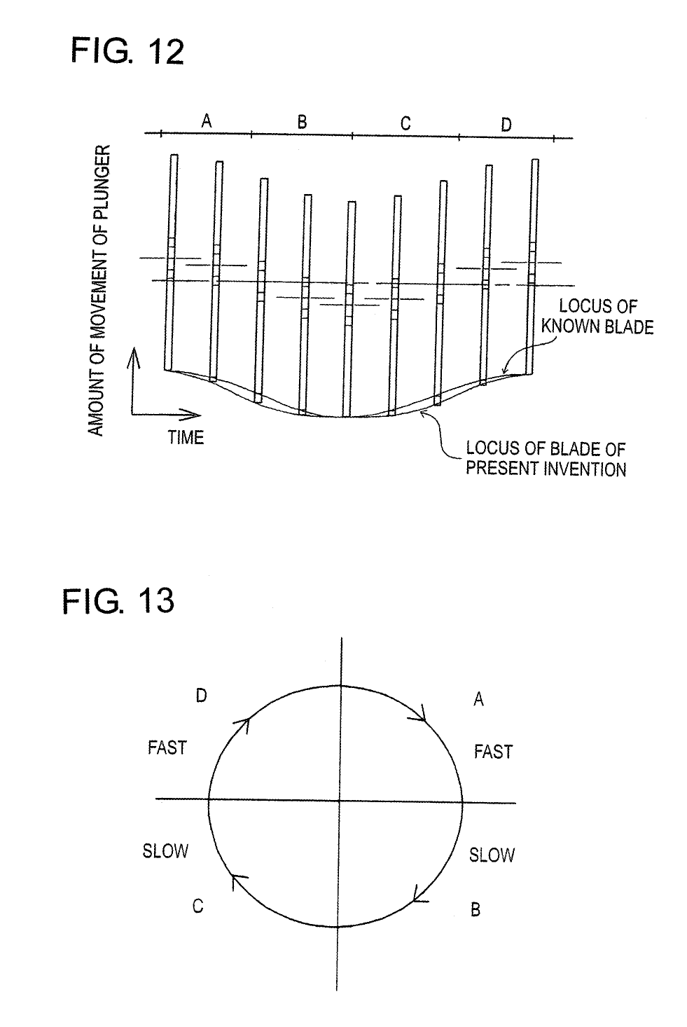

FIG. 12 is a diagram showing cutting loci of the lower ends 12a of the blade in the reciprocating tool 1 of the present exemplary embodiment and the known reciprocating tool. An area A, an area B, an area C and an area D shown in the drawing will be described hereinafter. The area A shows an area where the blade 12 supported by the plunger 10 is lowered from the upper dead point until being located at an intermediate point. That is, in the area A, the pin 8 moves in the right direction of FIG. 10, while pushing a lower right inner circumference of the curved part 10a, from the state shown in FIG. 10 until the plunger 10 reaches the intermediate point (i.e., until the pin 8 reaches a right end part of the curved part 10a). The area B shows an area where the blade 12 supported by the plunger 10 is lowered from the intermediate point until being located at a lower dead point. That is, in the area B, the pin 8 moves while pushing the lower right inner circumference of the curved part 10a, from the state where the pin 8 is at the right end part of the curved part 10a until the plunger 10 reaches the lower dead point (i.e., until the pin 8 reaches the center of the curved part 10a). The area C shows an area where the blade 12 supported by the plunger 10 is lifted from the lower dead point until being located at the intermediate point. That is, in the area C, the pin 8 moves in a left direction of FIG. 10, while pushing an upper left inner circumference of the curved part 10a, from the state shown in FIG. 10 until the plunger 10 reaches the intermediate point (i.e., until the pin 8 reaches a left end part of the curved part 10a). The area D shows an area where the blade supported by the plunger 10 is lifted from the intermediate point until being located at the upper dead point. That is, in the area D, the pin 8 moves while pushing the upper left inner circumference of the curved part 10a, from the state where the pin 8 is at the left end part of the curved part 10a until the plunger 10 reaches the upper dead point (i.e., until the pin 8 reaches the center of the curved part 10a). When the above-described areas are described by cutting states of the material to be cut, at a point where the area B is shifted to the area C, the blade 12 bites the material to be cut to start a cutting operation. The area C to the area D shows a stage where the material to be cut is cut. At a point where the area D is shifted to the area A, the blade 12 is separated from the material to be cut to finish a fragmentary cutting operation. The area A to the area B shows a state where the blade 12 is retreated from the material to be cut. In such a way, the area A, the area B, the area C, the area D and the area A are repeated to continuously cut the material to be cut.

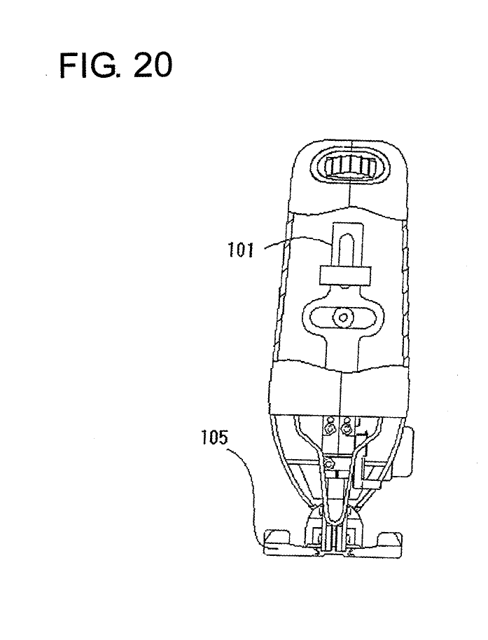

In the form (a through part has a straight form) of a known plunger 10 as shown in FIG. 20, an amount of bite of the blade 12 relative to the material to be cut is small from the area B to the area C. On the other hand, in the form (the form having the curved part 10a) of the plunger 10 of the present invention, since the blade 12 deeply bites the material to be cut at a lower speed, the cutting speed is improved, thereby improving workability.

FIG. 13 is a diagram showing a speed of the blade 12 of the reciprocating tool according to the exemplary embodiment of the present invention. Although the rotating speed of the gear 7 transmitted from the motor is constant, since the pin 8 engaged with the curved part 10a transversely moves in the curved part 10a, the speed of the upper-lower reciprocating movement of the plunger 10 changes respectively in the areas. When the blade 12 is located in a boundary of the area B and the area C (the lower dead point) and when the blade 12 is located in a boundary of the area D and the area A(the upper dead point), the pin 8 is located at the center of the curved part 10a. When the blade 12 is located in a boundary of the area A and the area B (the intermediate point) and when the blade 12 is located in a boundary of the area C and the area D (the intermediate point), the pin 8 is located at the left and right end parts of the curved part 10a. According to the above-described configuration, in the area A and the area D, the speed of the reciprocating movement of the plunger 10 increases. Meanwhile, in the area B and the area C, the speed of the reciprocating movement of the plunger 10 decreases.

In the form of the known plunger as shown in FIG. 20 and in the form of the plunger 10 of the present exemplary embodiment, the upper dead point and the lower dead point thereof are the same. When the pin 8 moves from the state shown in FIG. 10 to the right end part of the curved part 10a, by comparing a position of a central point of a penetration part of the known plunger and a position of the central point 8b of the curved part 10a of the present exemplary embodiment, that is, positions of the plungers, since the curved part 10a of the present exemplary embodiment is formed in the substantially U-shape, the position of the plunger 10 of the present exemplary embodiment is near to the lower dead point than that of the known plunger. Therefore, in the area A of FIG. 13, the plunger 10 moves at a shorter speed.

When the pin 8 moves from the right end side of the curved part 10a to the intermediate point (lower dead point), since the plunger 10 of the present exemplary embodiment has already moved more than the known plunger, a remaining distance to the lower dead point is shorter than the known plunger. Therefore, when a travel time between the upper dead point and the lower dead point is the same between the known plunger and the plunger 10 of the present embodiment, in the area B, since it is only necessary to move a shorter distance to the lower dead point in the same travel time, the plunger 10 moves at a slower speed than the known plunger.

When the pin 8 moves from the intermediate point (lower dead point) to the left end part of the curved part 10a, by comparing the position of the central point of the penetration part of the known plunger and the position of the central point 8b of the curved part 10a of the present exemplary embodiment, since the curved part 10a of the present exemplary embodiment is formed in the substantially U-shape, the moving distance of the present exemplary embodiment is shorter than that of the known plunger. Therefore, when a time until the pin 8 moves to the left end side of the curved part 10a is the same, since the moving distance of the plunger 10 of the present exemplary embodiment is shorter than that of the known plunger, the plunger 10 moves at a slower speed in the area C.

When the pin 8 moves from the left end side of the curved part 10a to the intermediate point (upper dead point), since the plunger 10 of the present has moved less than the known plunger, a remaining distance to the lower dead point is longer than the known plunger. Therefore, when a travel time between the upper dead point and the lower dead point is the same between the known plunger and the plunger 10 of the present exemplary embodiment, in the area D, since it is necessary to move a longer distance to the lower dead point in the same travel time, the plunger 10 moves at a faster speed than the known plunger.

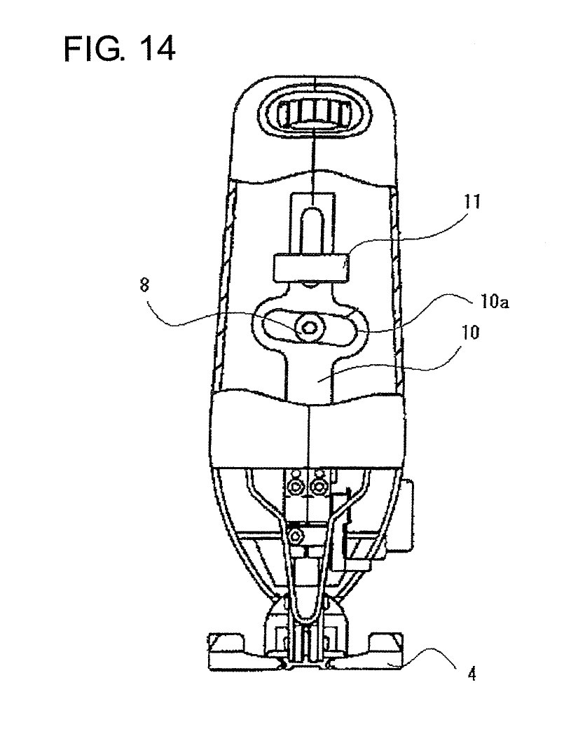

FIG. 14 shows a second shape of the curved part of the reciprocating tool according to the exemplary embodiment of the present invention and is a sectional view showing the reciprocating tool 1 seen from a cutting direction side. The plunger 10 supported by the plunger holder 11 slides in the upper-lower direction relative to the plunger holder 11. In the plunger 10, the curved part 10a which engages with the pin 8 is transversely formed in the direction intersecting the upper-lower direction in which the plunger 10 is configured to reciprocate. The pin 8 passes through the curved part 10a. When a point where the pin 8 is located on an axis of the reciprocation is a central point 8b, the curved part 10a is formed in a substantially point symmetrical shape with respect to the central point 8b. As one example, when the base 4 is seen as a lower part, a left side of the curved part 10a is formed so as to curve upward with respect to the central point 8b. On the contrary, a right side of the curved part 10a is formed so as to curve downward. In FIG. 14, the above-described form is shown. However, the exemplary embodiment is not limited thereto, and for instance, only the left side may be curved and the right side may have a straight form. Namely, it is only necessary that a part of the curved part 10a for supporting the pin 8 is curved upward when the blade is moved from a lower dead point to an upper dead point (when the pin 8 is moved to an upper part from a lower part). Further, a radius R of a curve of the pin 8 or the curved part 10a may take various values depending on products. In such a structure, the blade 12 can be rapidly operated until immediately before the blade 12 bites the material to be cut. Further, as soon as the blade 12 bites the material to be cut, since the locus of the blade 12 is deeper than a usual locus and the blade 12 bites the material to be cut at a lower speed than a usual speed, the cutting speed is improved, thereby improving workability. FIG. 14 shows a state where the plunger 10 is in the upper dead point. When the pin 8 moves in a right direction in FIG. 14, the plunger 10 moves in the lower direction.

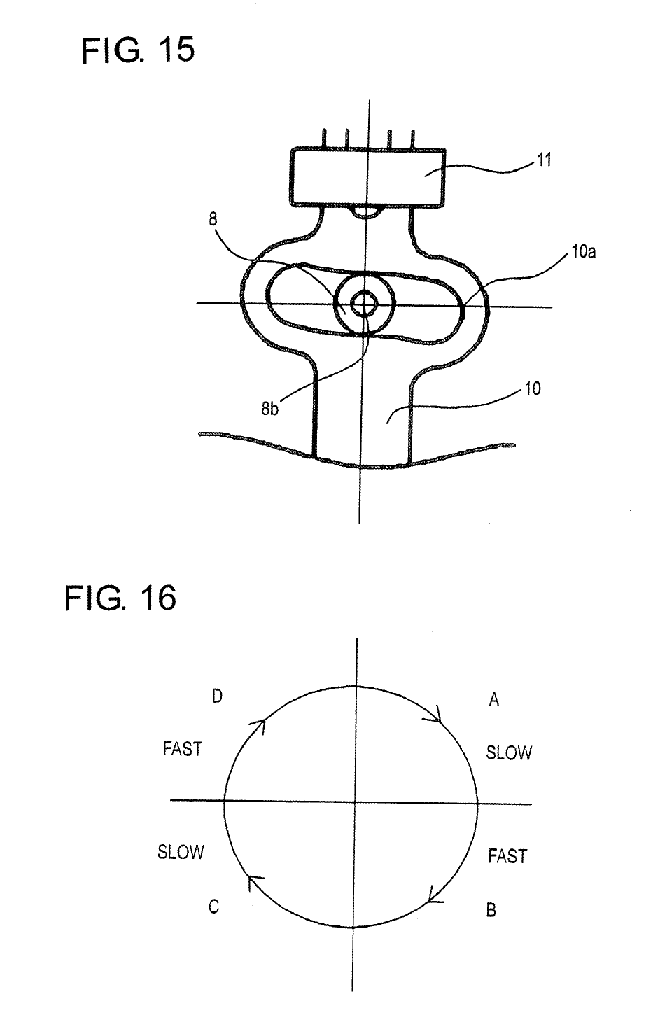

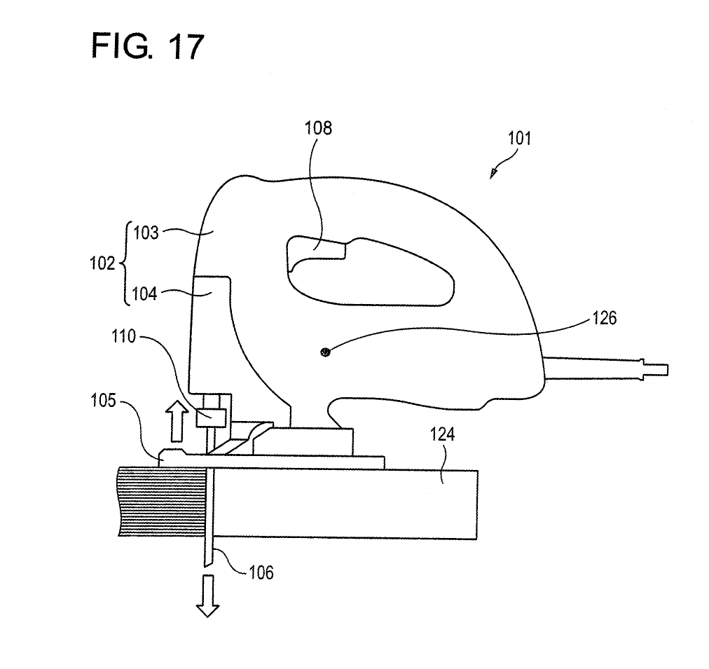

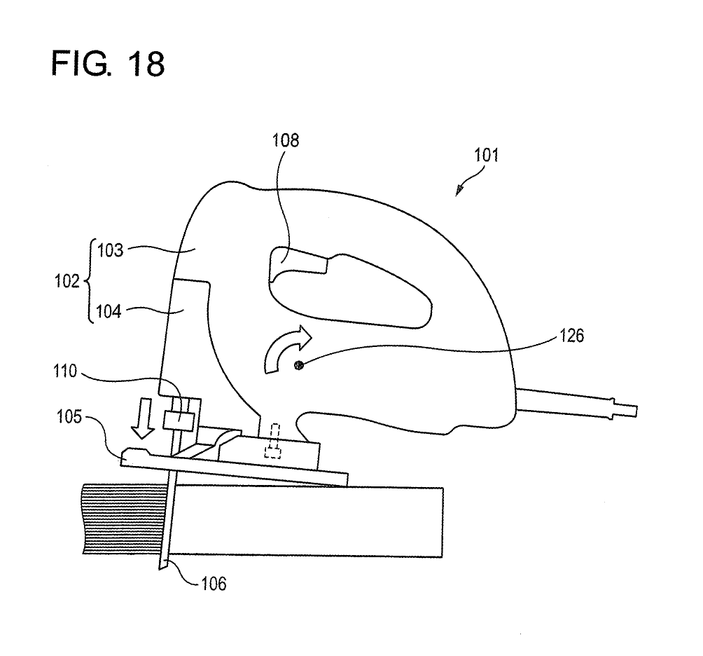

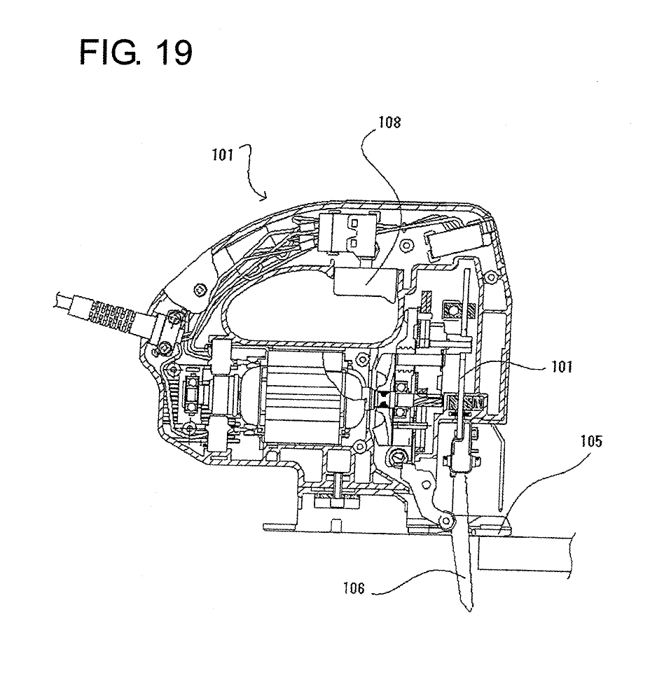

FIG. 15 is an enlarged view of a main part of the plunger 10 shown in FIG. 14. The pin 8, which is configured to rotate on the rotation shaft 5a, is located on the axis, on which the plunger 10 is configured to reciprocate, at a central point 8b. The central point 8b is located at a center in the transverse direction of the curved part 10a.

FIG. 16 is a diagram showing a speed of the blade of the reciprocating tool when the curved part of the reciprocating tool according to the exemplary embodiment of the present invention has the second shape. Although the rotating speed of the gear 7 transmitted from the motor is constant, since the pin 8 engaged with the curved part 10a transversely moves in the curved part 10a, the speed of the upper-lower reciprocating movement of the plunger 10 changes respectively in the areas. When the blade 12 is located in a boundary of the area B and the area C (the lower dead point) and when the blade 12 is located in a boundary of the area D and the area A (the upper dead point), the pin 8 is located at the center of the curved part 10a. When the blade 12 is located in a boundary of the area A and the area B (the intermediate point) and when the blade 12 is located in a boundary of the area C and the area D (the intermediate point), the pin 8 is located at right and left end parts of the curved part 10a. According to the above-described configuration, in the area B and the area D, the speed of the reciprocating movement of the plunger 10 increases. Meanwhile, in the area A and the area C, the speed of the reciprocating movement of the plunger 10 decreases.

In the form of the known plunger as shown in FIG. 20 and in the form of the plunger 10 of the present exemplary embodiment, the upper dead point and the lower dead point thereof are the same. When the pin 8 moves from the state shown in FIG. 14 to the right end part of the curved part 10a, by comparing a position of a central point of a penetration part of the known plunger and a position of the central point 8b of the curved part 10a of the present exemplary embodiment, that is, positions of the plungers, since the curved part 10a of the present exemplary embodiment is formed in the substantially U-shape, the moving distance of the plunger 10 of the present exemplary embodiment is shorter than that of the known plunger. Therefore, in the area A of FIG. 16, the plunger 10 moves at a shorter speed.

When the pin 8 moves from the right end side of the curved part 10a to the intermediate point (lower dead point), since the plunger 10 of the present exemplary embodiment has moved less than the known plunger, a remaining distance to the lower dead point is longer than the known plunger. Therefore, when a travel time between the upper dead point and the lower dead point is the same between the known plunger and the plunger 10 of the present exemplary embodiment, in the area B, since it is only necessary to move a shorter distance to the lower dead point in the same travel time, the plunger 10 moves at a slower speed than the known plunger.

Meanwhile, according to the areas C and D, the movement of the plunger is the same as that described in reference to FIGS. 10 to 13.

The present exemplary embodiment has been described by using the jigsaw However, the present invention may also be applied to a reciprocating tool such as a saver saw or a hammer drill having the same structure.

Further, a reciprocating tool may be configured to include an orbital mechanism described in the first half of the detailed description combined with the curved part 10a described in the latter half of the detailed description.

The present invention provides illustrative, non-limiting aspects as follows:

(1) According to a first aspect, there is provided a reciprocating tool including: a motor configured to rotate around a first rotating shaft; an outer frame that accommodates the motor; a base that is provided at a lower part of the outer frame; a rotating part configured to be rotary driven by the motor around a second rotating shaft, the rotating part including, a gear that is provided on the second rotating shaft, and a pin that is provided at an eccentric position of the gear; a plunger that engages with the pin and is configured to reciprocate in a vertical direction, on a reciprocation axis, in accordance with a vertical movement of the pin; and a curved part that is provided to the plunger, extends in a direction intersecting a reciprocating direction of the plunger and engages with the pin.

According to the first aspect, a blade more easily bites a material to be cut and a cutting speed is improved, thereby improving workability.

(2) According to a second aspect, there is provided the reciprocating tool according to the first aspect, wherein the curved part is formed in a substantially line symmetrical shape with respect to the reciprocation axis.

(3) According to a third aspect, there is provided the reciprocating tool according to the second aspect, wherein the curved part is formed in a substantially U-shape.

(4) According to a fourth aspect, there is provided the reciprocating tool according to the third aspect, wherein both end parts of the U-shape are curved upward.

(5) According to a fifth aspect, there is provided the reciprocating tool according to the first aspect, wherein a part of the curved part, to which the pin engages when the plunger moves from a lower dead point to an upper dead point, is curved upward.

According to the second to fifth aspects, since a locus of the blade before and after the blade bites the material to be cut is deeper than a usual locus and the blade bites the material to be cut at a speed lower than a usual speed, the cutting speed is improved, thereby improving workability.

(6) According to a sixth aspect, there is provided the reciprocating tool according to the first aspect, wherein the pin is located on the reciprocation axis at a central point, and wherein the curved part is formed in a substantially point symmetrical shape with respect to the central point.

(7) According to a seventh aspect, there is provided the reciprocating tool according to the sixth aspect, wherein a left side of the curved part is formed so as to curve upwards with respect to the central point.

According to the sixth and seventh aspects, since the blade can be rapidly operated until immediately before the blade bites the material to be cut, and as soon as the blade bites the material to be cut, the locus of the blade is deeper than a usual locus and the blade bites the material to be cut at a speed lower than a usual speed, the cutting speed is improved. As a result, workability is improved.

(8) According to an eighth aspect, there is provided the reciprocating tool according to any one of the first to seventh aspect, the reciprocating tool further including: a cam that is provided on the second rotating shaft and includes an outer peripheral surface, the outer peripheral surface including, a top part whose distance from a center of the second rotation shaft is the largest, a first area located in a rotating direction side of the top part such that a distance between the first area and the center of the second rotation shaft increases as the cam rotates, and a second area located in a side opposite to the rotating direction side of the top part such that a distance between the second area and the center of the second rotation shaft decreases as the cam rotates, wherein the rotating part includes the cam, and wherein a rate of change of the distance between the second area and the center of the second rotation shaft is larger than a rate of change of the distance between the first area and the center of the second rotation shaft.

According to the eighth aspect, even when an operator strongly pushes a main body forward and performs operation, the saw blade is already separated from a surface to be cut when the saw blade has reached an uppermost point, thereby reducing vibration generated in the main body. Further, chips are easily discharged and an unnecessary friction is eliminated between the saw blade and the surface to be cut to improve a cutting property. Further, in accordance with an orbital movement, the blade more easily bites the material be cut and the cutting speed improves, thereby improving workability.

(9) According to a ninth aspect, there is provided the reciprocating tool according to any one of the first to eighth aspects, the reciprocating tool further including: an intermediate member that abuts on the outer peripheral surface of the cam and reciprocates upward and downward in accordance with the outer peripheral surface of the cam; and a roller holder that is provided to the outer frame so as to oscillate freely and abuts on the intermediate member and a saw blade to move the saw blade forward when the intermediate member is moved downward and move the saw blade rearward when the intermediate member is moved upward.

This application claims priority from Japanese Patent Application No. 2010-222292 filed on Sep. 30, 2010, the entire contents of which are incorporated herein by reference.

### INDUSTRIAL APPLICABILITY

According to aspects of the present invention, there is provided a reciprocating tool where a blade thereof more easily bites a material to be cut and a cutting speed is improved, thereby improving workability.

1. A reciprocating tool comprising:
a motor configured to rotate around a first rotating shaft;
an outer frame that accommodates the motor;
a base that is provided at a lower part of the outer frame;
a rotating part configured to be rotary driven by the motor around a second rotating shaft, the rotating part including,
a gear that is provided on the second rotating shaft, and
a pin that is provided at an eccentric position of the gear;
a plunger that engages with the pin and is configured to reciprocate in a vertical direction, on a reciprocation axis, in accordance with a vertical movement of the pin;
a curved part that is provided to the plunger, extends in a direction intersecting a reciprocating direction of the plunger and engages with the pin;
an intermediate member that abuts on an outer peripheral surface of a cam reciprocates upward and downward in accordance with the outer peripheral surface of the cam; and
a roller holder that is provided to the outer frame so as to oscillate freely and abuts on the intermediate member and a saw blade to move the saw blade forward when the intermediate member is moved downward and move the saw blade rearward when the intermediate member is moved upward,
wherein a part of the curved part, to which the pin engages when the plunger moves from a lower dead point to an upper dead point is curved upward.

2. The reciprocating tool according to claim 1,
wherein the curved part is formed in a substantially line symmetrical shape with respect to the reciprocation axis.

3. The reciprocating tool according to claim 2,
wherein the curved part is formed in a substantially U-shape.

4. The reciprocating tool according to claim 3,
wherein both end parts of the U-shape are curved upward.

5. (canceled)

6. The reciprocating tool according to claim 1,
wherein the pin is located on the reciprocation axis at a central point, and
wherein the curved part is formed in a substantially point symmetrical shape with respect to the central point.

7. The reciprocating tool according to claim 6,
wherein a part of the curved part, to which the pin engages when the plunger moves from a lower dead point to an upper dead point, is curved upward.

8. The reciprocating tool according to claim 1,
wherein the cam is provided on the second rotating shaft and the outer peripheral surface includes,
a top part whose distance from a center of the second rotation shaft is the largest,
a first area located in a rotating direction side of the top part such that a distance between the first area and the center of the second rotation shaft increases as the cam rotates, and
a second area located in a side opposite to the rotating direction side of the top part such that a distance between the second area and the center of the second rotation shaft decreases as the cam rotates,
wherein the rotating part includes the cam, and
wherein a rate of change of the distance between the second area and the center of the second rotation shaft is larger than a rate of change of the distance between the first area and the center of the second rotation shaft.

9. (canceled)
